(19) United States
(12) Patent Application Publication
(10) Pub. No.: US 2010/0281916 A1
(43) Pub. Date: Nov. 11, 2010

(54) PROCESS FOR THE PURIFICATION OF AN HYDROCARBON GAS STREAM BY FREEZING OUT AND SEPARATING THE SOLIDIFIED ACIDIC CONTAMINANTS

(76) Inventor: Rick Van Der Vaart, Rijswijk (NL)

Correspondence Address: SHELL OIL COMPANY, P O BOX 2463, HOUSTON, TX, 772522463, US

(21) Appl. No.: 12/812,217

(22) PCT Filed: Jan. 9, 2009
(86) PCT No.: PCT/EP09/50197

§ 371 Date: Jul. 8, 2010

(30) Foreign Application Priority Data
Jan. 11, 2008 (EP) 08100380.8

(51) Int. Cl. F25J 3/06; B01D 53/00

(52) U.S. Cl. 62/625

(57) ABSTRACT

The present invention concerns a process for removing acidic contaminants and C2+-hydrocarbons from a feed gas stream (1) containing methane and acidic contaminants and C2+-hydrocarbons, the process comprising cooling (2) the feed gas stream to a temperature at which solid acidic contaminants are formed and a liquid comprising C2+-hydrocarbons and acidic contaminants as well as a methane enriched gaseous phase, separating (3) a gaseous stream (5) from the solids and liquid, introducing solids and liquid in the upper part of a separation/washing zone (4), the separation/washing zone comprising a downwardly moving bed of solids and removing solids at the lower end of the separation/washing zone, separating liquid from the solids through one or more openings (9) at a position between the upper part and the lower end of the separation/washing zone, and introducing at a position below the one or more openings an upwardly moving washing liquid.

The present invention concerns a process for removing acidic contaminants and C₂+-hydrocarbons from a feed gas stream containing methane and acidic contaminants and C₂+-hydrocarbons. The feed gas stream is especially natural gas contaminated with carbon dioxide in amounts larger than 10 vol %, more especially larger than 15 vol %, and/or hydrogen sulphide in amounts large than 5 vol %.

The removal of acidic contaminants, especially carbon dioxide and/or hydrogen sulphide, from methane containing gas streams has been described in a number of publications.

In WO 2004/070297 a process for removing contaminants from a natural gas stream is described. In the process water is removed from the feed gas stream by cooling resulting in methane hydrate formation, followed by separation of the hydrates and further cooling resulting in the formation of solid acidic contaminants. After separation of the solid acidic contaminants a cleaned natural gas stream is obtained.

In WO 03/062725 a process is described for the removal of freezable species from a natural gas stream by cooling a natural gas stream to form a slurry of solid acidic contaminants in compressed liquefied natural gas. The solids are separated from the liquid by means of cyclone.

In WO 2007/030888 a process is described similar to the process described in WO 2004/070297, followed by washing the cleaned natural gas stream with methanol.

There is still a need for a further improved process to remove carbon dioxide and/or hydrogen sulphide from natural gas streams. It is especially desired to restrict the amount of higher hydrocarbons, especially ethane, in the acidic contaminants stream that is removed from the process. Upon cooling of the natural gas stream to a temperature at which acidic contaminants as carbon dioxide and/or hydrogen sulphide are converted into the solid state, the higher hydrocarbons, especially the C₂-C₇ hydrocarbons, will be in the liquids state. C₈+-hydrocarbons may even be in the solid state. Upon separating the gaseous phase from solid phase, the liquid phase will adhere to the solids, and being separated from the process as part of the solids phase stream. This results in a loss of hydrocarbon product. The present process now provides the use of a washing liquid to remove the liquid hydrocarbons present on the solid acidic contaminant particles. The washing liquid is especially a liquid acidic contaminant as liquid carbon dioxide or liquid hydrogen sulphide.

The present invention, thus, concerns a process for removing acidic contaminants and C₂+-hydrocarbons from a feed gas stream containing methane and acidic contaminants and C₂+-hydrocarbons, the process comprising cooling the feed gas stream to a temperature at which solid acidic contaminants are formed and a liquid comprising C₂+-hydrocarbons and acidic contaminants as well as a methane enriched gaseous phase, separating a gaseous stream from the solids and liquid, introducing solids and liquid in the upper part of a separation/washing zone, the separation/washing zone comprising a downwardly moving bed of solids and removing solids at the lower end of the separation/washing zone, separating liquid from the solids through one or more openings at a position between the upper part and the lower end of the separation/washing zone, and introducing at a position below the one or more openings an upwardly moving washing liquid.

The feed gas stream containing methane and acidic contaminants may be any methane containing gas, for instance from natural sources as natural gas or from industrial sources as refinery streams or synthetic sources as Fischer-Tropsch streams or from biological sources as anaerobic waste or manure fermentation. The amount of methane present may vary over a wide range, e.g. from 3 to 90 vol %, especially from 5 to 90 vol % methane, preferably between 10 and 85 vol %, more preferably between 15 and 75 vol %.

The acidic contaminants in the feedstream are especially carbon dioxide and hydrogen sulphide, although also carbonyl sulphide (COS), carbon disulphide (CS2), mercaptans, sulphides and aromatic sulphur compounds may be present. Beside acidic contaminants, also inerts may be present, for instance nitrogen and noble gases as argon and helium. The amount of acidic contaminants present in the feed gas may vary over a wide range. The amount of carbon dioxide in the feed gas is suitably between 10 and 95 vol %, preferably between 15 and 90 vol %, more preferably between 20 and 75 vol %. The amount of hydrogen sulphide in the feed gas is suitably between 5 and 55 vol %, preferably between 10 and 45 vol %.

The amount of C₂+ hydrocarbons in the feed gas may vary over a large range. Suitably the amount of C₂+ hydrocarbons is between 0.1 and 25 vol %. Preferably there is in the feed gas between 0.2 and 22 vol % of C₂-C₈ hydrocarbons, more preferably between 0.3 and 18 vol % of C₂-C₄ hydrocarbons, especially between 0.5 and 15 vol % of ethane. Very suitably the feed gas is natural gas, associated gas, coal bed methane gas or biogas comprising acidic contaminants and C₂+-hydrocarbons. The term C₂+-hydrocarbons refers the ethane and higher hydrocarbons. The hydrocarbons comprise in principle all hydrocarbon compounds. Especially paraffins and monocyclic aromatic compounds will be present in the feed gas stream.

The amount of acidic contaminants that is removed by the process of the invention will depend on a number of factors. In practice, when using optimum conditions, at least 40 vol % (based on total acidic contaminants in the feed gas) of acidic contaminants will be removed, especially at least 60 vol %, preferably at least 75 vol %, more preferably at least 90 vol %. The liquid comprising the C₂+-hydrocarbons and acidic contaminants usually comprises between 10 and 95 mol % of C₂+-hydrocarbons, depending on the specific conditions (temperature, pressure and feed gas composition). Further, up till 30 mol % of methane may be present. In the case that there still is some water in the feed gas stream, this will in most of the cases end up in the solids phase, especially as hydrate, usually methane hydrate, hydrogen sulphide hydrate or carbon dioxide hydrate.

The cooling of the feed gas may be done by methods known in the art. For instance, cooling may be done against an external cooling fluid. In the case that the pressure of the feed gas is sufficiently high, cooling may be obtained by expansion of the feed gas stream. Combinations may also be possible. A suitable method to cool the feed gas stream is done by nearly isentropic expansion, especially by means of an expander, preferably a turbo expander or laval nozzle. Another suitable method is to cool the feed gas stream by isenthalpic expansion, preferably isenthalpic expansion over an orifice or a valve, especially over a Joule-Thomson valve. In a preferred embodiment the feed gas stream is pre-cooled before expansion. This may be done against an external cooling loop or against a cold process stream, e.g. liquid acidic contaminant. Preferably the gas stream is pre-cooled before expansion to a temperature between 15 and −45° C., preferably between 5° C. and −30° C. Pre-cooling may be done against internal process streams. Especially when the feed gas stream has been compressed, the temperature of the feed gas stream may be between 100 and 150° C. In that case air cooling may be used to decrease the temperature first, optionally followed by further cooling.

Another suitable cooling method is done by heat exchange against a cold fluidum, especially an external refrigerant, e.g. a propane cycle, an ethane/propane cascade or a mixed refrigerant cycle, optionally in combination with an internal process loop, suitably a carbon dioxide stream (liquid or slurry), a cold methane enriched stream or washing fluid.

Suitably the feed gas stream is cooled to a temperature between −40 and −100° C., especially between −50 and −80° C. At these temperatures solids are formed.

The raw feed gas stream may be pre-treated to partially or completely removal of water and optionally some heavy hydrocarbons. This can for instance be done by means of a pre-cooling cycle, against an external cooling loop or a cold internal process stream. Water may also be removed by means of pre-treatment with molecular sieves, e.g. zeolites, or silica gel or other drying agents. Water may also be removed by means washing with glycol, MEG, DEG or TEG, or glycerol. The amount of water in the gas feed stream is suitably less than 1 vol %, preferably less than 0.1 vol %, more preferably less than 0.01 vol %.

The feedstream for the process of the invention, optionally pretreated as described above, will suitably have a pressure between 10 and 120 bara, or even up till 160 bara. Especially, the feedstream has a pressure between 15 and 70 bara, preferably between 20 and 50 bara. The feedstream, preferably pretreated, suitably has a temperature between −30 and 150° C., suitably between −20 and 70° C., preferably between 0 and 50° C.

The process of the invention is suitably be carried out by introducing the cooled feed gas stream in a separation zone in order to separate the gas phase from the solid/liquid phase. This may suitably be done by introducing the cooled gas stream into the middle of the separation zone and using gravitational forces to separate the gas stream from the solid/liquid stream. It is also possible to use centrifugal force to separate the components, e.g. by using a cyclone. In general all techniques known in the art may be used to separate the phases. In a preferred embodiment the gaseous stream is separated from the solids and liquid in a separation zone, which zone is situated above the separation/washing zone. Suitably the separation zone is a large empty space, e.g. a large, vertical tubular section. Suitably also the separation washing zone is a large vertical tubular section, especially of the same diameter as the separation zone and fluidly connected to each other. It is, however, also possible that the separation zone is wider than the separation/washing zone, or just the reverse. In another embodiment, at least part of the separation/washing zone may have a conical shape, either upwardly or downwardly. In yet another embodiment, the separation zone and the separation/washing zone are separate devices with means for transferring the liquid/solids slurry from the separation device into the separation/washing device.

Suitably all solids and liquid are introduced into the separation/washing zone. Suitably all gas is removed via the separation zone. The solids will form a fixed bed in the separation/washing zone, flowing downwards in plug flow mode. The washing liquid that is introduced into the lower end of the separating/washing zone flows countercurrent with respect to the solids.

The separation/washing zone may be divided into three zones, an upper zone in which the solids bed is build up, a separation zone where the liquid is removed from the separation/washing zone and a washing zone where the washing liquid moves upwardly and removes the liquid C₂+-hydrocarbons and the liquid acidic contaminants from the solids.

Suitably the liquid is withdrawn via openings in the separation washing zone. These openings are especially perforated or porous tubes, preferably vertical tubes, especially a plurality of vertical tubes. These tubes may extend through the separation zone or through the bottom of the separation/washing zone. The tubes may also be present in one or more horizontal layers, and extending via the wall of the separation/washing zone.

In another embodiment the liquid is withdrawn via openings which are present in the form of a perforated or porous outer wall of the separation zone.

Suitably the washing liquid is liquid acidic contaminant, especially the washing liquid is carbon dioxide, especially having a purity of at least 90%, more especially a purity of at least 95%, even more especially a purity of at least 99%, or the washing liquid is hydrogen sulphide, especially having a purity of at least 90%, more especially a purity of at least 95%, even more especially a purity of at least 99%.

The washing liquid may be introduced into the separation/washing zone via one or more pipes extending via the wall into the separation/washing zone. In another embodiment there is a circular distribution device, fed by one or more feeding lines extending from the wall of the separation/washing zone or from the bottom or the top zone into the separation zone.

Another way of generating the washing liquid is melting the acidic contaminants at the lower end of the separation/washing zone and removing less acidic contaminant than introduced via the feed gas stream. In that way a (small) stream of liquid acidic contaminants is generated that will leave the process as an upflow stream in the separation/washing section via the openings provided for the removal of the liquid fraction.

The amount of washing liquid is suitably less than 10 wt % of the amount of acidic contaminants introduced into the separation/washing zone, preferably less than 5 wt %, more preferably less than 2 wt %.

The amount of introduced or generated washing liquid suitably has a volume up to the volume of the acidic contaminants in the acidic contaminants/C₂+-hydrocarbons liquid removed from the separation/washing zone, especially a fraction between 0.01 and 0.75 of the volume of the acidic contaminants, more especially between 0.05 and 0.25.

In yet another embodiment, an amount of introduced or generated washing liquid is recycled to the separation section above the separation/washing section, with the goal to alter the liquids to solids ratio of the slurry that enters the separation/washing section to enable proper hydraulic operation of the moving bed of solid contaminants, especially a fraction between 0.01 and 0.75 of the volume of the acidic contaminants, more especially between 0.05 and 0.25.

The liquid separated from the solids is suitably heated to obtain a gaseous mixture of acidic contaminants and C₂+-hydrocarbons, where after the acidic contaminants are removed from the gaseous stream by absorption, especially absorption with an aqueous amine solution. In that way an additional amount of hydrocarbons is obtained from the process.

In another embodiment the liquid separated from the solids is cryogenically distilled in order to separate the acidic contaminants from the C₂+-hydrocarbons. In that way an additional amount of hydrocarbons is obtained from the process. It is also possible to regasify the stream and use the gaseous stream as fuel gas, especially when the amount of hydrogen sulphide is low.

In a further embodiment the liquid separated from the solids, optionally after gasification, is mixed with product gas or fuel gas with lower acidic contaminants concentration to make the liquid composition suitable for utilisation in e.g. a gas turbine.

The acidic contaminants, especially carbon dioxide, may suitably be used for enhanced oil recovery. In another embodiment is the carbon dioxide is sequestrated. The hydrogen sulphide may also be converted into sulphur, and used for instance in the manufacture of sulphuric acid.

The invention also concerns A device for carrying out the process as described above.

The invention also concerns purified natural gas obtained by a process as described above.

The invention also concerns a process for liquefying natural gas comprising purifying the natural gas in the way as described above, followed by liquefying the natural gas by methods known in the art. In that case suitably a further purification step is carried out to remove acidic contaminants, suitably a washing step with a chemical or physical solvent, e.g. an aqueous amine solution or a stream of cold methanol.

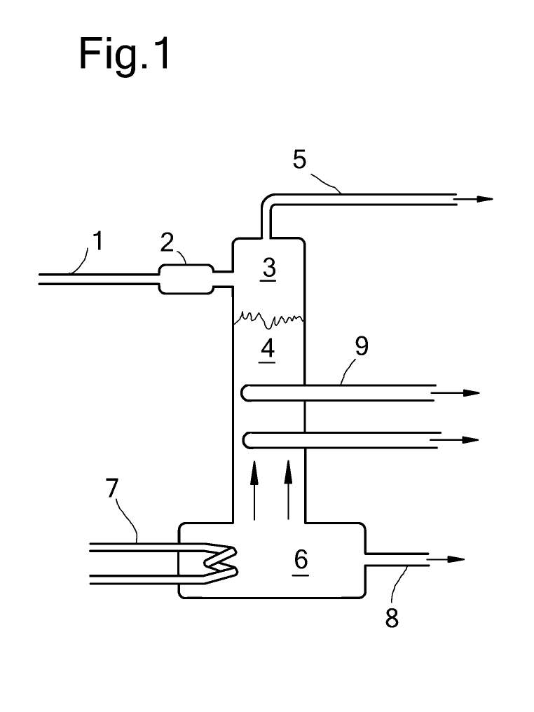

The invention is further explained by means of FIG. 1. A dry feed gas stream 1 (water content 20 ppmw, 60 bara) is cooled by means of a Joule Thomson valve 2 till a temperature of −70° C. at a pressure of 15 bara. The feed gas contains 40 vol % carbon dioxide, 5 vol % ethane, 2 vol % propane and 1 vol % C₃+-hydrocarbons and 52 vol % methane. The resulting gas/solids/liquids mixture is introduced into separating zone 3. Here the enriched methane stream 5 is separated from the solids/liquids. The solids build up fixed bed of solid particles in the separation/washing zone 4. Liquid is withdrawn from the separation/washing zone 4 via perforated pipes 9. Carbon dioxide is melted in section 6. Heat is introduced via heating coils 7. Liquid carbon dioxide is withdrawn from the melting section via pipe 8. The amount of liquid carbon dioxide withdrawn from 6 is less than the amount of carbon dioxide introduced in the separation/washing zone, resulting in a countercurrent stream of carbon dioxide in the lower part of zone 4.

### EXAMPLE

The table below gives the conditions, flows and compositions of the different streams that would occur in a CO2-contaminated natural gas treatment process according to the current invention. “Inlet” corresponds to dry feed gas Stream 1, “HC vapour” corresponds to the enriched methane Stream 5, “HC liquid” corresponds to the liquid withdrawn via perforated Pipes 9, “molten CO2” corresponds to the liquid carbon dioxide withdrawn via pipe 8 and “CO2 wash” corresponds to the liquid that flows from Section 6 into the lower section of Zone 4 in FIG. 1.

| | | | | molten | CO2 |
|---|---|---|---|---|---|
| Parameters | Inlet | HC vapor | HC liquid | CO2 | wash |
| Pressure (bar) | 54.3 | 17 | 17 | 17 | 17 |
| Temperature (C.) | −62.25 | −62.4 | −62.4 | −54.35 | −54.35 |
| Flow rate (kgmol/hr) | 74680 | 44860 | 1638 | 29680 | 1488 |
| Mole Fractions | | | | | — |
| CO2 | 0.53981 | 0.24397 | 0.72014 | 0.99923 | 0.99923 |
| H2S | 0.00005 | 0.00007 | 0.00034 | 0.00000 | 0.00000 |
| N2 | 0.02401 | 0.03990 | 0.00207 | 0.00001 | 0.00001 |
| Methane | 0.42013 | 0.69502 | 0.12345 | 0.00034 | 0.00034 |
| Ethane | 0.01100 | 0.01714 | 0.03246 | 0.00009 | 0.00009 |
| Propane | 0.00200 | 0.00244 | 0.02459 | 0.00007 | 0.00007 |
| i-Butane | 0.00100 | 0.00076 | 0.02490 | 0.00007 | 0.00007 |
| n-Butane | 0.00100 | 0.00054 | 0.03104 | 0.00009 | 0.00009 |
| i-Pentane | 0.00050 | 0.00011 | 0.01991 | 0.00005 | 0.00005 |
| n-Pentane | 0.00050 | 0.00007 | 0.02101 | 0.00006 | 0.00006 |

1. A process for removing acidic contaminants and C₂+-hydrocarbons from a feed gas stream containing methane and acidic contaminants and C₂+-hydrocarbons, the process comprising:
cooling the feed gas stream to a temperature at which solid acidic contaminants are formed and a liquid is formed comprising C₂+-hydrocarbons and acidic contaminants as well as a methane enriched gaseous phase is formed;
separating a gaseous stream from the solids and liquid;
introducing solids and liquid in the upper part of a separation/washing zone, the separation/washing zone comprising a downwardly moving bed of solids and removing solids at the lower end of the separation/washing zone;
separating liquid from the solids through one or more openings at a position between the upper part and the lower end of the separation/washing zone; and
introducing at a position below the one or more openings an upwardly moving washing liquid, wherein the washing liquid flows countercurrently with respect to the solids.

2. A process according to claim 1, in which the feed gas contains between 5 and 90 vol % methane

3. A process according to claim 1, in which the feed gas contains between 10 and 95 vol % of carbon dioxide.

4. A process according to claim 1, in which the feed gas contains between 0.1 and 25 vol % of C₂+-hydrocarbons.

5. A process according to claim 1, in which the feed gas stream has a temperature between −30° C. and 150° C.,

6. A process according to claim 1, in which the cooling is done by nearly isentropic expansion.

7. A process according to claim 1, in which the feed gas stream is cooled to a temperature between −40 and −100° C.

8. A process according to claim 1, in which the gaseous stream is separated from the solids and liquid in a separation zone, which zone is situated above the separation/washing zone.

9. A process according to claim 1, in which the openings via which liquid is withdrawn are perforated or porous tubes.

10. A process according to claim 1, in which the washing liquid comprises carbon dioxide.

11. A process according to claim 1, in which the washing liquid is introduced into the separation/washing zone via one or more pipes in the lower end of the zone.

12. A process according to claim 1, in which the washing liquid is generated by melting solid acidic contaminants at the lower end of the separation washing zone and partial removal of the molten acidic contaminants.

13. A process according to claim 12, in which a fraction of the molten washing liquid obtained at the lower end of the separation/washing zone is recycled into the gas/liquid/solid separation zone above the separation/washing zone.

14. (canceled)

15. (canceled)
